(19) United States
(12) Patent Application Publication
(10) Pub. No.: US 2013/0052932 A1
(43) Pub. Date: Feb. 28, 2013

(54) METHOD AND DEVICE FOR EVACUATING HOLLOW SPACES

(71) Applicant: Meinhard Schwaiger, Linz (AT)

(72) Inventor: Meinhard Schwaiger, Linz (AT)

(73) Assignee: AMX AUTOMATION TECHNOLOGIES GMBH, Linz (AT)

(21) Appl. No.: 13/574,956

(22) PCT Filed: Jan. 20, 2011
(86) PCT No.: PCT/EP2011/050717

§ 371 Date: Aug. 10, 2012

(30) Foreign Application Priority Data
Jan. 26, 2010 (AT) A 102/2010
Jan. 26, 2010 (AT) A 103/2010

(51) Int. Cl. E06B 7/02

(52) U.S. Cl. 454/196

(57) ABSTRACT

The invention relates to a method and a device for evacuating hollow spaces, especially hollow sections (1″, 1′″, 1″″) of plastic windows, wherein an opening (16) is produced in an outer wall (18) of the hollow section (1″, 1′″, 1″″). Air is evacuated from the hollow section (1″, 1′″, 1″″) and the opening (16) is then closed. In order to improve the insulating effect of said method and device, the opening (16) is closed off by a suction tube (8) and a seal (2) is put onto the opening (16) to close the same once the air has been evacuated.

The present invention relates to a method for evacuating hollow spaces, especially hollow chambers of plastic windows according to the preamble of claim 1. The invention especially relates to a method in which an opening is produced in an outer wall of the hollow space, air is evacuated from the hollow space and the opening is closed off afterwards.

A frame within the terms of the present invention shall be understood as being both a casement and also a block frame. The invention can be applied not only to windows but also to doors or the like, even when only windows are discussed below for reasons of simplicity.

Plastic windows offer the advantage of good thermal insulation among other things, which is achieved in such a way that the used profiles are arranged as hollow chamber profiles. The ability for thermal insulation increases with rising number of the so-called insulation chambers. Current window systems with two to eight chambers correspond to the state of the art. It is disadvantageous that profile systems with an increasing number of hollow chambers or hollow spaces have a higher overall depth and lead to higher production costs. The higher production costs are the result of higher material input in combination with decreasing production speed. Systems with 8 chambers have a 50% higher weight and an overall depth of approximately 75 mm, while a three-chamber system can manage with an overall depth of 50 mm.

The insulation effect in plastic window systems is based on the insulating capability of air. Plastic windows consist among other things of a window frame and a casement which is made of mitered profiles by means of welding in the corners. Encapsulated chambers are produced in this manner in which the air is encapsulated. The insulating properties of multi-chamber systems are low as a result of physics involved. The heat transfer from one chamber to the next occurs by a thermal conduction in PVC (λ_{PVC}=0.15 W/mK) and via convection and thermal conduction of the encapsulated air (λₐᵢᵣ=0.026 W/mK). As a result, it is not the additional number of hollow chambers which is apparently advantageous, but only the additional overall depth (clearance of the profile chambers), because the contribution of convection in heat transfer depends on the temperature difference (for forming a required circulation of the gas) between the adjacent walls of the hollow chambers, which decreases strongly however with rising number of hollow chambers.

A further measure for increasing thermal insulation was tried by introducing insulating foamed material (e.g. PU high-resistance foam (λ_{PU}=0.035 W/mK)), but with little success because such systems lead to high production costs, can be recycled only within limits and have large overall depths.

In summary, the disadvantages in multi-chamber systems are low thermal insulation in combination with large overall depth and high production costs.

It is known from DE 195 37 459 C1 or EP 0 556 600 B1 to improve the insulating properties of a window profile in such a way that individual hollow chambers are evacuated. This allows reducing the thermal losses in the main section of a window profile. It has proven to be problematic from a production viewpoint to produce the vacuum in the interior of the hollow spaces.

It is the object of the present invention to provide a method with which it is possible to evacuate one or several profile chambers, with the sealing of the opening through which the air is evacuated occurring in a simple and durable way. It is a further object of the present invention to further develop the method in such a way that several profile chambers can be evacuated in a manner acceptable to production.

These objects are achieved in accordance with the invention by the features of claim 1. It is especially provided that the opening is sealed by a suction trunk and a seal is applied to the opening directly after the evacuation of the air in order to close of said opening, whereupon the suction trunk is preferably lifted off. The relevant aspect is that the evacuation and closing of the opening is performed in one clamping with a tool in order to reliably prevent any entrance of infiltrated air. As a result, a pressure in a range of 10⁻³ mbar (fine vacuum) up to 100 mbar (absolute) can easily be achieved. The thermal properties can be improved considerably by such a pressure level because the heat transfer in gases will cease nearly entirely in a fine vacuum, so that the fulfilment of the standards for low-energy or passive-energy houses is relevantly facilitated.

It is advantageous when the seal is moved relative to the outer wall of the hollow space in order to connect the seal thermally with the outer wall of the hollow space. The connection occurs in the manner which corresponds to friction welding. As a result of the occurring frictional heat, the seal which preferably consists of PVC and the outer wall which also consists of PVC will be heated to such an extent at the point of contact that melting down of the items in the joining will occur on the joining surface and a durable connection will be created. The movement can principally occur in an oscillatory manner, e.g. in the ultrasonic sound frequency range. It is especially preferred when the movement is a rotational movement. This rotational movement usually occurs about the axis of the opening.

It is certainly possible to apply the seal in a planar fashion to the outside wall. The connection can be arranged in an especially secure manner when the seal is introduced at least partly into the opening. As a result, an interlocking and additionally friction-locked connection can be produced because the seal will penetrate the opening on the one hand and will close the same itself, and additional sealing will occur on the other hand in the region of the outer surface around the seal.

An especially advantageous embodiment of the method in accordance with the invention provides that the evacuation consists of a first step in which a first vacuum is produced, whereupon a noble gas is allowed to flow into the opening, and a second step in which the final vacuum is produced. The insulation effect can be amplified in this manner because noble gases show an outstanding insulating effect especially at reduced pressure, i.e. a reduced thermal conductivity, because there is both a reduced pressure and also a gas composition enriched with noble gas.

It is especially advantageous if before the evacuation at least one transfer opening is produced between the first hollow chamber and a further hollow chamber. This allows evacuating several chambers of the profile through one single opening. It is generally required that the individual chambers of a profile or a frame are separated from one another in order to prevent convection flows which are responsible for undesirable thermal transport. It has been noticed surprisingly however that individual transfer openings are not detrimental if they are provided with a sufficiently small configuration and unless there are several transfer openings which are provided in especially remote manner from one another.

The production can especially be facilitated in such a way that the transfer opening is produced in the region of the mitered profile sections prior to welding in that a recess is produced in a web. This arrangement has also proven to be advantageous from a flow point of view in order to achieve rapid and efficient evacuation.

The present invention further relates to an apparatus for evacuating hollow spaces, especially hollow chambers of plastic windows, comprising a suction trunk for evacuating air from an opening.

This apparatus is characterized in accordance with the invention in such a way that a stamp which is movable in the axial direction is arranged in the suction trunk, which stamp is arranged for pressing a seal onto the opening. Evacuation of air can be performed in this way when the stamp has been retracted. In particular, the stamp can be retracted behind the actual suction trunk, so that the lumen is not blocked by installed parts, which is advantageous for the efficiency during evacuation. The stamp is used for pressing and moving the seal.

An especially advantageous embodiment of the invention provides that the stamp is arranged to be rotatable. The required frictional heat for welding can be produced by the rotational movement. Typical speeds are between 500 min⁻¹ and 12,000 min⁻¹. It is advantageous when the rotational movement comes to a standstill very quickly after reaching the fusing point. A reliable connection can be produced in this manner.

The stamp is situated in the region which is operatively kept at a low pressure level, so that the mechanism should be arranged in an especially careful way. It is especially advantageous if the presence of lubricants, pneumatic or hydraulic components can be avoided in this area. It has proven to be especially advantageous if a hermetically sealed magnetic coupling is provided in order to transmit a torque onto the stamp. The evacuated area can completely be encapsulated in this way. Only lubricant-free plastic plain bearings are provided in the interior so that the above considerations are taken into account. It is also advantageous in this respect that an electromagnet is provided in order to press the stamp together with the seal onto the opening. The axial movement can thereby also be arranged in a non-critical manner.

An especially advantageous sealing of the stamp during the evacuation can be achieved when the stamp is provided at its front end with a blade which is arranged to be pressed in a sealing manner against the outer wall.

The present invention further relates to a plastic window with a frame which consists of several profile sections provided with hollow chambers which are welded at the ends, with at least one first hollow chamber being evacuated.

This plastic window is characterized in accordance with the invention in such a way that a transfer opening is provided between the first hollow chamber and a further hollow chamber. The flow connection allows evacuating several chambers simultaneously. Preferably, only one respective transfer opening is arranged between two chambers, which transfer opening is sufficiently dimensioned in order to ensure efficient evacuation. Depending on the size of the frame, the cross-sectional area is between 5 mm² and 200 m², but can also lie beneath 5 mm² in the case of respectively efficient evacuation tools.

It is especially preferably provided that the transfer opening is arranged in a web in a corner region of the frame, which web is arranged between the first hollow chamber and the further hollow chamber. This has proven to be especially advantageous from a production point of view.

It is further preferred when the opening for evacuation is arranged in a visible area of the frame. Especially effective sealing can be achieved during the evacuation in this manner because visible areas offer special quality concerning flat configuration and smooth surface for aesthetic reasons.

The present invention will be explained below by reference to embodiments shown in the drawings, wherein:

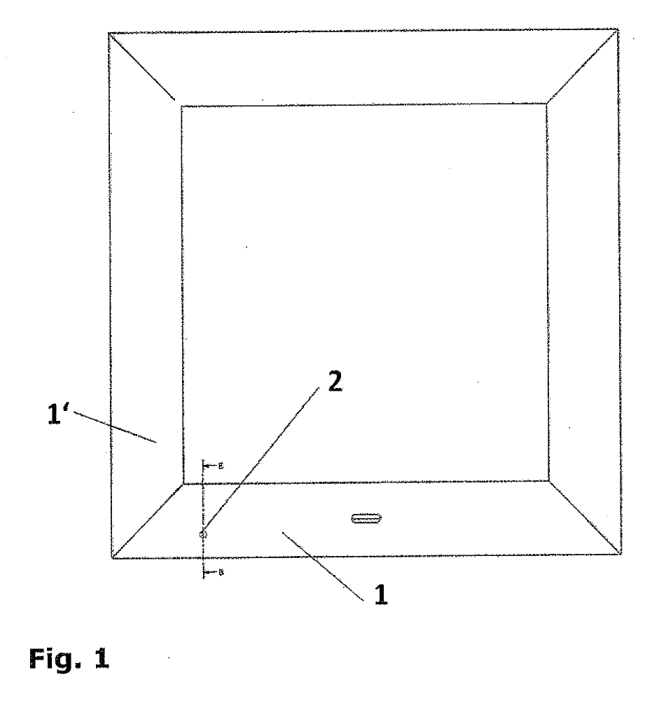

FIG. 1 schematically shows a window frame in a front view;

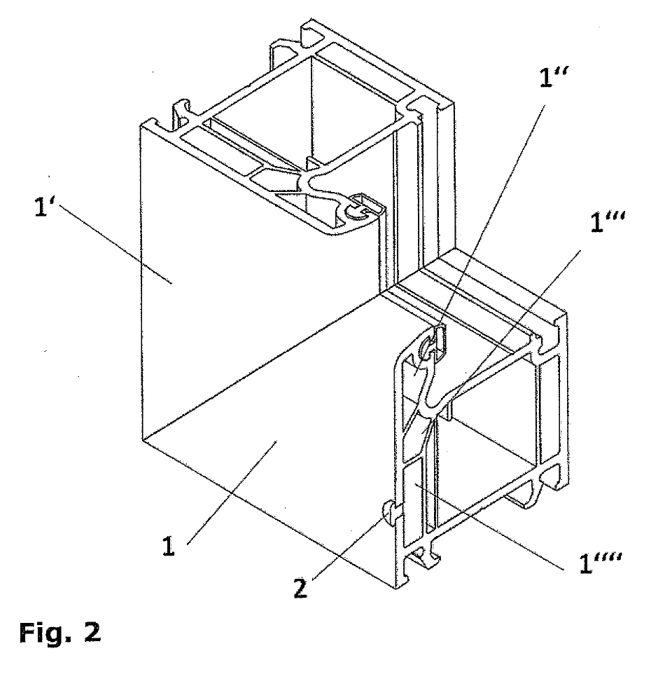

FIG. 2 shows a detail of the window frame of FIG. 1 in an axonometric view;

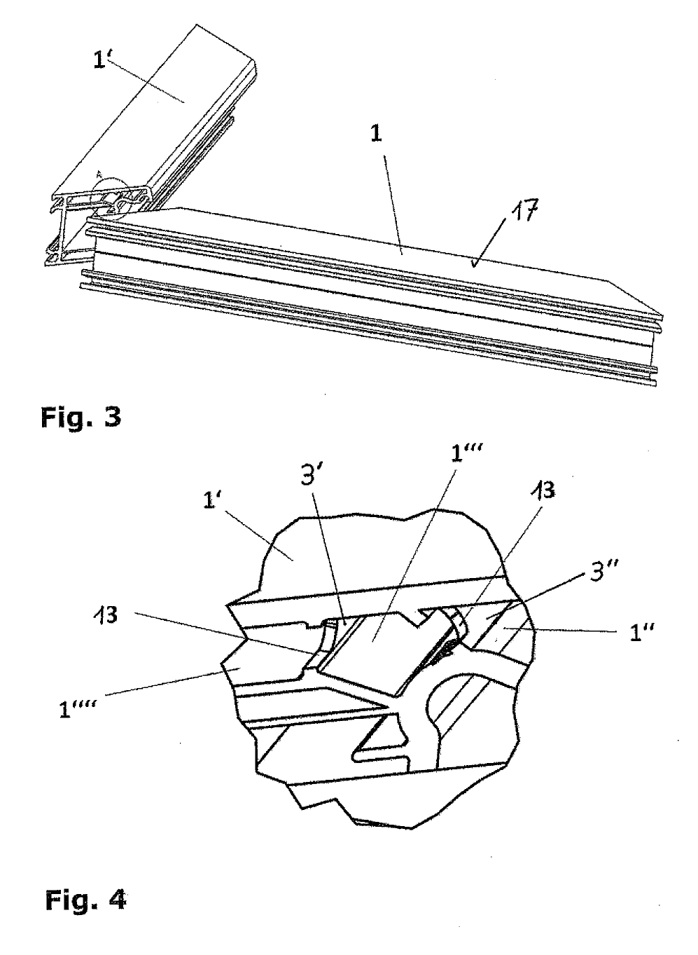

FIG. 3 shows an exploded view of a part of a window frame;

FIG. 4 shows a detail of FIG. 1;

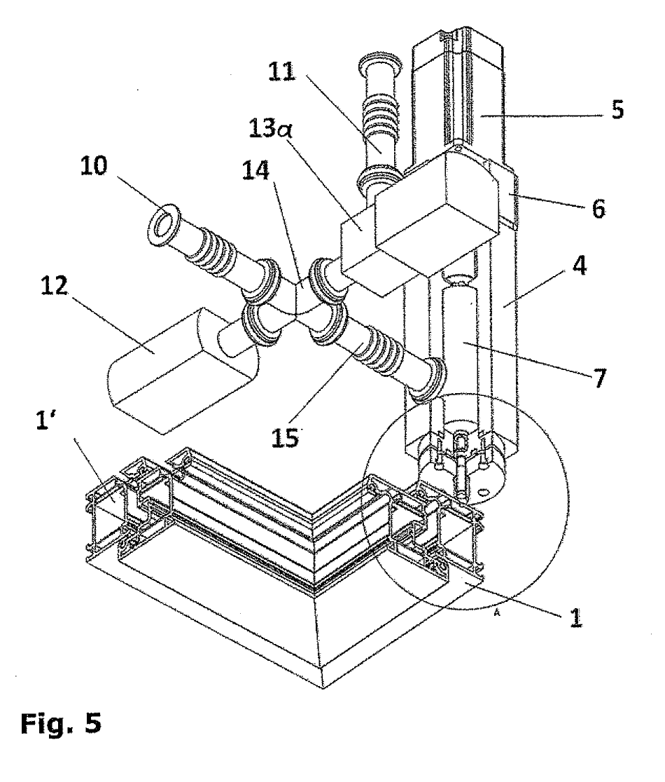

FIG. 5 shows an apparatus for evacuating air, and

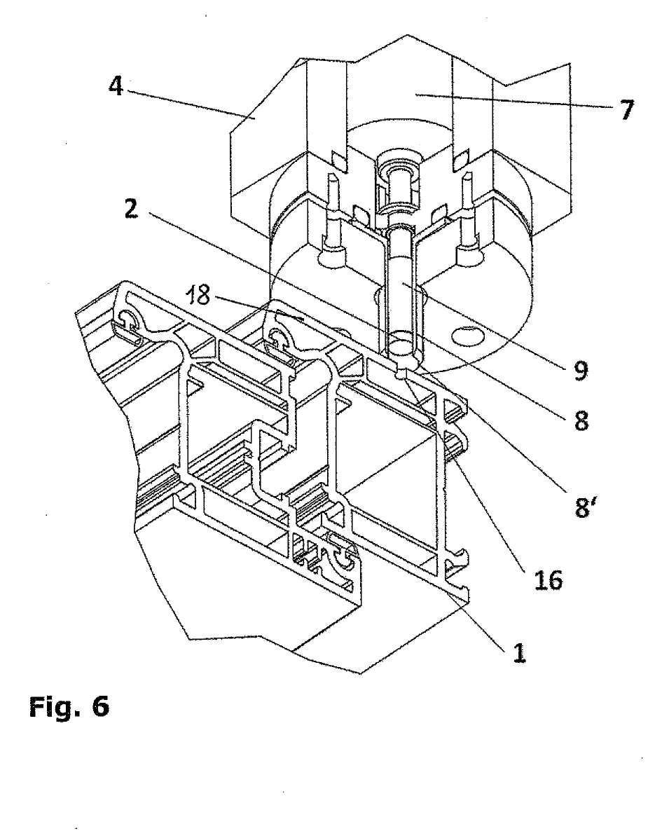

FIG. 6 shows a detail of FIG. 5.

FIG. 1 shows a window frame in a front view, consisting of a horizontal bottom profile bar 1 and a vertical profile bar 1′, with the bottom horizontal profile bar 1 being provided with a seal 2 which seals a vacuum chamber (not shown here).

FIG. 2 shows a detailed view of the corner of the window frame of FIG. 1, consisting of the profile bars 1, 1′, the seal 2, the hollow chambers 1″, 1′″, 1″″, with at least hollow chamber 1″″ being evacuated.

FIG. 3 shows a corner of the frame, comprising mitered profile bars 1, 1′ before welding of the profile bars into a window frame.

FIG. 4 shows the detail A of FIG. 3, which is the exposed area 13 of the webs 3′, 3″, which is arranged as the transfer opening, so that the vacuum can be produced in the hollow chambers 1″, 1′″, 1″″, with only one suction opening in one of the profile bars 1, 1′. The exposed area 13 will be milled off prior to welding of the profile bars 1, 1′.

FIG. 5 shows the apparatus in accordance with the invention for producing the vacuum in the hollow chambers 1″, 1′″, 1″″. The apparatus consists of a base body 4 and the drive motor 5 which is flanged thereon for generating the rotational movement of the seal 2. The interior space of the base body 4 is hermetically sealed, so that the drive motor 5 will not be influenced by vacuum and will operate under ambient pressure. The torque of the drive motor 5 will be transmitted via a magnetic coupling 6.

A feed unit 7 is preferably arranged as a lifting magnet in order to generate the pressing pressure on the stamp 9 in the axial direction.

Furthermore, a connecting line to the vacuum pump 10, a connecting line 11 for filling with noble gas, a vacuum pressure sensor 12 for process monitoring, a vacuum switching valve 13a for feeding noble gases, a line part 14 and a connecting line 15 to the apparatus are provided.

FIG. 6 shows a detailed view (8) FIG. 5. The suction trunk 8 with the front edge 8′ which is arranged as a sharp blade will be pressed tightly against the surface 18 arranged in a visible surface 17 of the frame via an opening 16 arranged as a borehole in the profile bar 1, so that a vacuum-tight connection of the suction trunk 8 with the profile surface is provided. The movable stamp 9 accommodates the seal 2 and presses the same against the opening 16 after the performed evacuation of the hollow chamber(s) 1″, 1′″, 1″″, makes the seal 2 rotate or oscillate in another way, so that welding of the seal 2 with the profile bar 1 occurs under vacuum under pressing pressure generated by the feed unit 7 and under movement generated by the drive motor 5.

1. A method for evacuating hollow spaces, especially hollow chambers (1″, 1′″, 1″″) of plastic windows, in which an opening (16) is produced in an outer wall (18) of the hollow chamber (1″, 1′″, 1″″), air is evacuated from the hollow chamber (1″, 1′″, 1″″) and the opening (16) is thereafter closed off, wherein the opening (16) is closed off by a suction trunk (8) and a seal (2) is applied to the opening (16) directly after the evacuation of the air in order to close off said opening.

2. The method according to claim 1, wherein the suction trunk (8) is lifted off after the application of the seal (2) onto the opening (16).

3. The method according to claim 2, wherein the seal (2) is moved in relation to the outer wall (18) of the hollow chamber (1″, 1′″, 1″″) in order to thermally connect the seal (2) with the outer wall (18) of the hollow chamber (1″, 1′″, 1″″), with the movement preferably being a rotational movement or a translatory oscillation.

4. The method according to claim 1, wherein the seal (2) is introduced at least partly into the opening (16).

5. The method according to claim 1, wherein the seal (2) is pressed against the opening (16) by magnetic force.

6. The method according to claim 1, wherein the evacuation consists of a first step in which a first vacuum is produced, whereupon a noble gas is allowed to flow into the opening (16), and of a second step in which the final vacuum is produced.

7. The method according to claim 1, wherein several mitered profile sections (1, 1′) provided with several hollow chambers (1″, 1′″, 1″″) are welded at the ends in order to form a frame, and that at least one first hollow chamber (1″) is evacuated in that the opening (16) is produced in an outer wall (18) of the first hollow chamber (1″), air is evacuated from the first hollow chamber (1″) and thereupon the opening (16) is closed off, and that prior to the evacuation and preferably prior to the welding at least one transfer opening is produced in form of an exposed area (13) in a web (3′, 3″) between the first hollow chamber (1″) and a further hollow chamber (1′″, 1″″).

8. An apparatus for the evacuation of hollow spaces, especially hollow chambers (1″, 1′″, 1″″) of plastic windows, comprising a suction trunk (8) for evacuating air from an opening, wherein a stamp (9) is arranged in the suction trunk (8), which stamp is movable in the axial direction and is arranged for pressing a seal (2) onto the opening (16).

9. The apparatus according to claim 8, wherein the stamp (9) is rotatably arranged and that preferably a magnetic coupling (6) is provided in order to transfer a torque onto the stamp (9).

10. The apparatus according to claim 8, wherein an electromagnet (7) is provided in order to press the stamp (9) plus seal (2) onto the opening.

11. The apparatus according to claim 8, wherein the suction trunk (8) has a blade (8′) at its front end, which blade is arranged to be pressed in a sealing manner against the outer wall (18).

12. A plastic window with a frame which consists of several profile sections (1, 1′) provided with hollow chambers (1″, 1′″, 1″″), which profile sections are welded together at the ends, with at least one first hollow chamber (1″) being evacuated, characterized in that at least one transfer opening in form of an exposed area (13) is provided in a web (3′, 3″) between the first hollow chamber (1″) and a further hollow chamber (1′″, 1″″).

13. The plastic window according to claim 12, wherein the transfer opening is arranged in a corner region of the frame in a web (3′, 3″) which is arranged between the first hollow chamber (1″) and the further hollow chamber (1′″, 1″″).

14. The plastic window according to claim 12, wherein the opening (16) is arranged for evacuation in a visible surface (17) of the frame.

15. The plastic window according to claim 12, wherein the pressure in the first hollow chamber (1″) is between 10-3 mbar and 100 mbar, and that the hollow chamber (1″) can preferably mainly be filled with a noble gas.

16. The plastic window according to claim 12, wherein the opening (16) for evacuation is closed off by a seal (2) which is connected by means of friction welding, gluing or interlocking with the outer wall (18).
